(19) United States
(12) Patent Application Publication
(10) Pub. No.: US 2021/0356118 A1
(43) Pub. Date: Nov. 18, 2021

(54) PURE OXYGEN COMBUSTION METHOD WITH LOW NITROGEN SOURCE

(71) Applicant: UNIVERSITY OF SCIENCE AND TECHNOLOGY BEIJING, Beijing (CN)

(72) Inventors: Shengen Zhang, Beijing (CN); Lin Li, Beijing (CN); Bo Liu, Beijing (CN); Bolin Zhang, Beijing (CN)

(21) Appl. No.: 16/335,677

(22) PCT Filed: Nov. 30, 2017
(86) PCT No.: PCT/CN2017/113975

§ 371 Date: Mar. 22, 2019

(30) Foreign Application Priority Data
Nov. 29, 2017 (CN) 201711222240.6

(51) Int. Cl. F23C 5/32; F23L 7/00; F23K 3/02

(52) U.S. Cl. CPC F23C 5/32; F23L 2900/07005; F23K 3/02; F23L 7/007

(57) ABSTRACT

A pure oxygen combustion method with a low nitrogen source is provided, relating to a technical field of thermal engineering. The method includes steps of: adopting a low nitrogen fuel, and adopting pure oxygen as a combustion-supporting gas; separately transporting the pure oxygen and the low nitrogen fuel; controlling a ratio of the pure oxygen to the low nitrogen fuel; and combusting tangentially in the pure oxygen in a combustion chamber, so as to realize deep burnout of the low nitrogen fuel and decrease CO and NOₓ emission concentrations. The present invention realizes nitrogen source reduction before combustion, reduces NOₓ emissions, and increases a thermal energy conversion efficiency of the fuel, without a flue gas de-nitrification device. Therefore, a NOₓ emission concentration is 5-100 mg/m³, a CO emission concentration is 50-500 mg/m³, and a combustion efficiency of the fuel is beyond 95%.

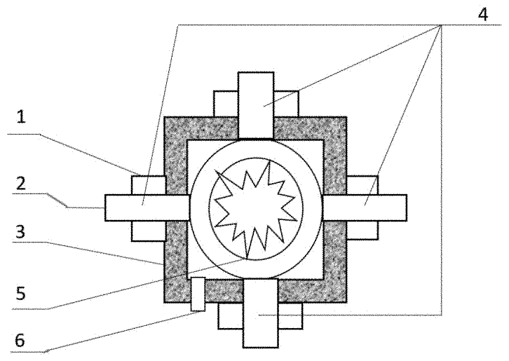

### CROSS REFERENCE OF RELATED APPLICATION

This is a U.S. National Stage under 35 U.S.C 371 of the International Application PCT/CN2017/113975, filed Nov. 30, 2017, which claims priority under 35 U.S.C. 119(a-d) to CN 201711222240.6, filed Nov. 29, 2017.

### BACKGROUND OF THE PRESENT INVENTION

### Field of Invention

The present invention relates to a technical field of thermal engineering, and more particularly to a pure oxygen combustion method with a low nitrogen source.

### Description of Related Arts

Nitrogen oxides (NOₓ) generated by combustion are one of main atmospheric pollutants. There are mainly two kinds of NO generated during combustion. One is fuel NOₓ, which generates from burning of nitrogen rich fuel, the other is thermal NOₓ, generated by nitrogen in the combustion-supporting gas combined with oxygen at a high temperature. Low NOₓ emission is carried out mainly by low nitrogen combustion or gas de-nitrification technologies. The concentration of the generated thermal NOₓ is positively correlated with the square of burning temperature. The low nitrogen combustion technology is carried out by controlling the burning temperature through the staged combustion technology. The generation of thermal NOₓ can be decreased when the burning temperature is not beyond 1100° C. Although the staged combustion technology can decrease generation of the thermal NOₓ, the emission concentration of NOₓ is far beyond 50 mg/m³, requiring the expensive and complex de-nitrification system; moreover, due to the in-efficient combustion, the emission concentration of CO is high (1000-20000 mg/m³), and the thermal energy conversion efficiency of the fuel is low.

To reduce NOₓ emissions, the Chinese patent publication (CN104132344A) discloses a non-flame fuel gas combustion device with an ultra-low NOₓ emission and a combustion method, realizing the ultra-low NOₓ emission (about 5 ppm) by the non-flame combustion of premixed fuel gas. This patent is only applicable to the combustion of gaseous fuel with air, which contains much nitrogen. The low burning temperature leads to the low thermal energy conversion efficiency and high CO emission concentration. The Chinese patent publication (CN205782803U) discloses a flue gas circulation oxygen-rich combustion system for thermal power plant boilers, realizing the low NOₓ emissions of pulverized coal boilers through the flue gas circulation oxygen-rich combustion technology. However, low levels of oxygen in the combustion-supporting gas is not enough to achieve deep combustion burnout of low NOₓ, leading to the high CO emission concentration and low thermal energy conversion efficiency of the fuel, which requires the expensive and complex de-nitrification system. The Chinese patent publication (CN106482150A) discloses the power station boiler NOₓ control system and method with air staging/local oxygen-rich combustion, which reach the NOₓ emission standard through air staging and the SNCR (selective non-catalytic reduction) de-nitrification technology inside the furnace. However, the SNCR de-nitrification technology will lead to the decreased combustion efficiency of the fuel and the high CO emission concentration. The Chinese patent publication (CN106594718A) discloses a flat flow oxygen-rich burner for the pulverized coal boiler. High-efficiency combustion and reduction of the thermal NOₓ are achieved by pure oxygen combustion. Nevertheless, for the flat flow combustion, combination of the pulverized coal and combustion-supporting gas is non-ideal; the combustion is in-efficient; the relatively high nitrogen content (generally more than 0.5%) of the fuel leads to the high NOₓ emission concentration; and the expensive and complex de-nitrification system is required for combustion.

### SUMMARY OF THE PRESENT INVENTION

In order to solve issues of high NOₓ and CO emission concentrations and complex de-nitrification system existing in the conventional low nitrogen combustion technology, the present invention provides a pure oxygen combustion method with a low nitrogen source. The present invention prevents fuel NOₓ and thermal NOₓ through combustion of pure oxygen, so as to achieve the deep burnout of fuel, greatly decrease the CO emission concentration, and realize the ultra-low NOₓ and CO emissions without the flue gas de-nitrification system. The present invention realizes the clean combustion and burnout of fuel without the expensive green facility, which is a subversive clean to combustion technology.

The present invention adopts following technical solutions.

A pure oxygen combustion method with a low nitrogen source comprises steps of: adopting a low nitrogen fuel, and adopting pure oxygen as a combustion-supporting gas; separately transporting the pure oxygen and the low nitrogen fuel; controlling a ratio of the pure oxygen to the low nitrogen fuel; and combusting tangentially in the pure oxygen in a combustion chamber, so as to improve a thermal energy conversion efficiency of the fuel and decrease CO and NOₓ emission concentrations.

Preferably, the low nitrogen fuel is one of low nitrogen solid fuel, low nitrogen liquid fuel and low nitrogen gas fuel.

Preferably, the low nitrogen solid fuel comprises at least one of low nitrogen pulverized coal and graphite powders; the low nitrogen liquid fuel comprises at least one member selected from a group consisting of gasoline, kerosene, diesel oil and heavy oil; and the low nitrogen gas fuel comprises at least one of natural gas and water gas.

Preferably, if the low nitrogen fuel is the low nitrogen solid fuel, the low nitrogen solid fuel is transported with protection of carbon dioxide.

Preferably, a stoichiometric ratio of the pure oxygen to the low nitrogen fuel is controlled to be 1.0-1.5.

Preferably, the step of “combusting tangentially in the pure oxygen in a combustion chamber” particularly comprises steps of: after separately transporting the pure oxygen and the low nitrogen fuel through a pure oxygen pipeline and a low nitrogen fuel pipeline, spraying the pure oxygen and the low nitrogen fuel into the combustion chamber in a tangential direction through burners, wherein four burners are evenly arranged in the combustion chamber; and then combusting tangentially in the pure oxygen, so as to ensure efficient combustion by the low nitrogen fuel.

Preferably, after combusting tangentially in the pure oxygen in the combustion chamber, a NOₓ emission concentration is 5-100 mg/m³, a CO emission concentration is 50-500 mg/m³, and a combustion efficiency of the low nitrogen fuel is beyond 95%.

Advantages of the present invention are described as follows.

(1) The method of the present invention reduces fuel NOₓ by removing nitrogen in the fuel with technical means or using the non-nitrogen or ultra-low nitrogen fuel.

(2) The method of the present invention reduces thermal NOₓ by combusting in pure oxygen, so as to avoid the nitrogen in the combustion-supporting gas.

(3) The method of the present invention realizes deep burnout, which greatly reduces the CO emission concentration and increases the thermal energy conversion efficiency of the fuel.

(4) The method of the present invention does not require the flue gas de-nitrification system, which reduces the environmental protection investment and avoids the pollution problem causing the spent catalyst.

### BRIEF DESCRIPTION OF THE DRAWINGS

The FIGURE is a sketch view of a pure oxygen combustion method with a low nitrogen source according to the present invention.

In the FIGURE: 1—low nitrogen fuel pipeline; 2—pure oxygen pipeline; 3—combustion chamber; 4—burner; 5—flame; and 6—gas outlet.

### DETAILED DESCRIPTION OF THE PREFERRED EMBODIMENT

The present invention will be further described in detail with reference to the accompanying drawings and examples, so as to provide a better understanding of the present invention for one skilled in the art. The examples described in the following detailed description of the present invention are merely for further illustrating the present invention, not for inappropriately limiting the present invention.

### EXAMPLE 1

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.1%; and the flue gas de-nitrification device is not required.

### EXAMPLE 2

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.1. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 10 mg/m³ and 450 mg/m³; the combustion efficiency is 95.5%; and the flue gas de-nitrification device is not required.

### EXAMPLE 3

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.15. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 15 mg/m³ and 400 mg/m³; the combustion efficiency is 96%; and the flue gas de-nitrification device is not required.

EXAMPLE 4

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.2. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 300 mg/m³; the combustion efficiency is 96.5%; and the flue gas de-nitrification device is not required.

### EXAMPLE 5

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.25. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 25 mg/m³ and 260 mg/m³; the combustion efficiency is 97%; and the flue gas de-nitrification device is not required.

### EXAMPLE 6

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.3. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 30 mg/m³ and 200 mg/m³; the combustion efficiency is 97%; and the flue gas de-nitrification device is not required.

### EXAMPLE 7

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.4. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 50 mg/m³ and 100 mg/m³; the combustion efficiency is 97.2%; and the flue gas de-nitrification device is not required.

### EXAMPLE 8

De-nitrogen pulverized coal is transported through a low nitrogen fuel pipeline 1 with protection of CO₂, and pure oxygen is transported through a pure oxygen pipeline 2, wherein a stoichiometric ratio of the pure oxygen to the pulverized coal is 1.5. The pure oxygen and the pulverized coal are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98%; and the flue gas de-nitrification device is not required.

### EXAMPLE 9

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 10

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1.1. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 11

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1.2. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 12

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1.3. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 13

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1.4. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 14

Graphite powders are transported through a low nitrogen fuel pipeline 1 with protection of CO₂, and pure oxygen is transported through a pure oxygen pipeline 2, wherein a stoichiometric ratio of the pure oxygen to the graphite powders is 1.5. The pure oxygen and the graphite powders are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 15

Gasoline is transported through a low nitrogen fuel pipeline 1, and pure oxygen is transported through a pure oxygen pipeline 2, wherein a stoichiometric ratio of the pure oxygen to the gasoline is 1. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 16

Gasoline is transported through a low nitrogen fuel pipeline 1, and pure oxygen is transported through a pure oxygen pipeline 2, wherein a stoichiometric ratio of the pure oxygen to the gasoline is 1.1. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 17

Gasoline is transported through a low nitrogen fuel pipeline 1, and pure oxygen is transported through a pure oxygen pipeline 2, wherein a stoichiometric ratio of the pure oxygen to the gasoline is 1.2. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 18

Gasoline is transported through a low nitrogen fuel pipeline 1, and pure oxygen is transported through a pure oxygen pipeline 2, wherein a stoichiometric ratio of the pure oxygen to the gasoline is 1.3. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 19

Gasoline is transported through a low nitrogen fuel pipeline 1, and pure oxygen is transported through a pure oxygen pipeline 2, wherein a stoichiometric ratio of the pure oxygen to the gasoline is 1.4. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 20

Gasoline is transported through a low nitrogen fuel pipeline 1, and pure oxygen is transported through a pure oxygen pipeline 2, wherein a stoichiometric ratio of the pure oxygen to the gasoline is 1.5. The pure oxygen and the gasoline are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 21

Kerosene is transported through a low nitrogen fuel pipeline 1, and pure oxygen is transported through a pure oxygen pipeline 2, wherein a stoichiometric ratio of the pure oxygen to the kerosene is 1. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 22

Kerosene is transported through a low nitrogen fuel pipeline 1, and pure oxygen is transported through a pure oxygen pipeline 2, wherein a stoichiometric ratio of the pure oxygen to the kerosene is 1.1. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 23

Kerosene is transported through a low nitrogen fuel pipeline 1, and pure oxygen is transported through a pure oxygen pipeline 2, wherein a stoichiometric ratio of the pure oxygen to the kerosene is 1.2. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 24

Kerosene is transported through a low nitrogen fuel pipeline 1, and pure oxygen is transported through a pure oxygen pipeline 2, wherein a stoichiometric ratio of the pure oxygen to the kerosene is 1.3. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 25

Kerosene is transported through a low nitrogen fuel pipeline 1, and pure oxygen is transported through a pure oxygen pipeline 2, wherein a stoichiometric ratio of the pure oxygen to the kerosene is 1.4. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 26

Kerosene is transported through a low nitrogen fuel pipeline 1, and pure oxygen is transported through a pure oxygen pipeline 2, wherein a stoichiometric ratio of the pure oxygen to the kerosene is 1.5. The pure oxygen and the kerosene are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 27

Diesel oil is transported through a low nitrogen fuel pipeline 1, and pure oxygen is transported through a pure oxygen pipeline 2, wherein a stoichiometric ratio of the pure oxygen to the diesel oil is 1. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 28

Diesel oil is transported through a low nitrogen fuel pipeline 1, and pure oxygen is transported through a pure oxygen pipeline 2, wherein a stoichiometric ratio of the pure oxygen to the diesel oil is 1.1. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 29

Diesel oil is transported through a low nitrogen fuel pipeline 1, and pure oxygen is transported through a pure oxygen pipeline 2, wherein a stoichiometric ratio of the pure oxygen to the diesel oil is 1.2. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 30

Diesel oil is transported through a low nitrogen fuel pipeline 1, and pure oxygen is transported through a pure oxygen pipeline 2, wherein a stoichiometric ratio of the pure oxygen to the diesel oil is 1.3. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 31

Diesel oil is transported through a low nitrogen fuel pipeline 1, and pure oxygen is transported through a pure oxygen pipeline 2, wherein a stoichiometric ratio of the pure oxygen to the diesel oil is 1.4. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 32

Diesel oil is transported through a low nitrogen fuel pipeline 1, and pure oxygen is transported through a pure oxygen pipeline 2, wherein a stoichiometric ratio of the pure oxygen to the diesel oil is 1.5. The pure oxygen and the diesel oil are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 33

Heavy oil is transported through a low nitrogen fuel pipeline 1, and pure oxygen is transported through a pure oxygen pipeline 2, wherein a stoichiometric ratio of the pure oxygen to the heavy oil is 1. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 34

Heavy oil is transported through a low nitrogen fuel pipeline 1, and pure oxygen is transported through a pure oxygen pipeline 2, wherein a stoichiometric ratio of the pure oxygen to the heavy oil is 1.1. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 35

Heavy oil is transported through a low nitrogen fuel pipeline 1, and pure oxygen is transported through a pure oxygen pipeline 2, wherein a stoichiometric ratio of the pure oxygen to the heavy oil is 1.2. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 36

Heavy oil is transported through a low nitrogen fuel pipeline 1, and pure oxygen is transported through a pure oxygen pipeline 2, wherein a stoichiometric ratio of the pure oxygen to the heavy oil is 1.3. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 37

Heavy oil is transported through a low nitrogen fuel pipeline 1, and pure oxygen is transported through a pure oxygen pipeline 2, wherein a stoichiometric ratio of the pure oxygen to the heavy oil is 1.4. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 38

Heavy oil is transported through a low nitrogen fuel pipeline 1, and pure oxygen is transported through a pure oxygen pipeline 2, wherein a stoichiometric ratio of the pure oxygen to the heavy oil is 1.5. The pure oxygen and the heavy oil are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 39

Natural gas is transported through a low nitrogen fuel pipeline 1, and pure oxygen is transported through a pure oxygen pipeline 2, wherein a stoichiometric ratio of the pure oxygen to the natural gas is 1. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 40

Natural gas is transported through a low nitrogen fuel pipeline 1, and pure oxygen is transported through a pure oxygen pipeline 2, wherein a stoichiometric ratio of the pure oxygen to the natural gas is 1.1. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 41

Natural gas is transported through a low nitrogen fuel pipeline 1, and pure oxygen is transported through a pure oxygen pipeline 2, wherein a stoichiometric ratio of the pure oxygen to the natural gas is 1.2. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 42

Natural gas is transported through a low nitrogen fuel pipeline 1, and pure oxygen is transported through a pure oxygen pipeline 2, wherein a stoichiometric ratio of the pure oxygen to the natural gas is 1.3. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 43

Natural gas is transported through a low nitrogen fuel pipeline 1, and pure oxygen is transported through a pure oxygen pipeline 2, wherein a stoichiometric ratio of the pure oxygen to the natural gas is 1.4. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 44

Natural gas is transported through a low nitrogen fuel pipeline 1, and pure oxygen is transported through a pure oxygen pipeline 2, wherein a stoichiometric ratio of the pure oxygen to the natural gas is 1.5. The pure oxygen and the natural gas are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

### EXAMPLE 45

Water gas is transported through a low nitrogen fuel pipeline 1, and pure oxygen is transported through a pure oxygen pipeline 2, wherein a stoichiometric ratio of the pure oxygen to the water gas is 1. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 5 mg/m³ and 500 mg/m³; the combustion efficiency is 95.2%; and the flue gas de-nitrification device is not required.

### EXAMPLE 46

Water gas is transported through a low nitrogen fuel pipeline 1, and pure oxygen is transported through a pure oxygen pipeline 2, wherein a stoichiometric ratio of the pure oxygen to the water gas is 1.1. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 20 mg/m³ and 400 mg/m³; the combustion efficiency is 96%; and the flue gas de-nitrification device is not required.

### EXAMPLE 47

Water gas is transported through a low nitrogen fuel pipeline 1, and pure oxygen is transported through a pure oxygen pipeline 2, wherein a stoichiometric ratio of the pure oxygen to the water gas is 1.2. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 40 mg/m³ and 300 mg/m³; the combustion efficiency is 96.5%; and the flue gas de-nitrification device is not required.

### EXAMPLE 48

Water gas is transported through a low nitrogen fuel pipeline 1, and pure oxygen is transported through a pure oxygen pipeline 2, wherein a stoichiometric ratio of the pure oxygen to the water gas is 1.3. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 60 mg/m³ and 200 mg/m³; the combustion efficiency is 97%; and the flue gas de-nitrification device is not required.

### EXAMPLE 49

Water gas is transported through a low nitrogen fuel pipeline 1, and pure oxygen is transported through a pure oxygen pipeline 2, wherein a stoichiometric ratio of the pure oxygen to the water gas is 1.4. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 80 mg/m³ and 100 mg/m³; the combustion efficiency is 98%; and the flue gas de-nitrification device is not required.

### EXAMPLE 50

Water gas is transported through a low nitrogen fuel pipeline 1, and pure oxygen is transported through a pure oxygen pipeline 2, wherein a stoichiometric ratio of the pure oxygen to the water gas is 1.5. The pure oxygen and the water gas are sprayed into a combustion chamber 3 through burners 4, so as to tangentially combust in the pure oxygen and generate a flame 5. The NOₓ and CO emission concentrations, measured at a gas outlet 6, are respectively 100 mg/m³ and 50 mg/m³; the combustion efficiency is 98.5%; and the flue gas de-nitrification device is not required.

What is claimed is:

1. A pure oxygen combustion method with a low nitrogen source, comprising steps of: adopting a low nitrogen fuel, and adopting pure oxygen as a combustion-supporting gas; separately transporting the pure oxygen and the low nitrogen fuel; controlling a ratio of the pure oxygen to the low nitrogen fuel; and combusting tangentially in the pure oxygen in a combustion chamber, so as to improve a thermal energy conversion efficiency of the fuel and decrease CO and NOₓ emission concentrations.

2. The method, as recited in claim 1, wherein the low nitrogen fuel is one of low nitrogen solid fuel, low nitrogen liquid fuel and low nitrogen gas fuel.

3. The method, as recited in claim 2, wherein: the low nitrogen solid fuel comprises at least one of low nitrogen pulverized coal and graphite powders; the low nitrogen liquid fuel comprises at least one member selected from a group consisting of gasoline, kerosene, diesel oil and heavy oil; and the low nitrogen gas fuel comprises at least one of natural gas and water gas.

4. The method, as recited in claim 3, wherein: if the low nitrogen fuel is the low nitrogen solid fuel, the low nitrogen solid fuel is transported with protection of carbon dioxide.

5. The method, as recited in claim 1, wherein a stoichiometric ratio of the pure oxygen to the low nitrogen fuel is controlled to be 1.0-1.5.

6. The method, as recited in claim 1, wherein the step of “combusting tangentially in the pure oxygen in a combustion chamber” particularly comprises steps of: spraying the pure oxygen and the low nitrogen fuel into the combustion chamber in a tangential direction through burners, wherein four burners are evenly arranged in the combustion chamber; and then combusting tangentially in the pure oxygen, so as to ensure efficient combustion by the low nitrogen fuel.

7. The method, as recited in claim 1, wherein: after combusting tangentially in the pure oxygen in the combustion chamber, a NOₓ emission concentration is 5-100 mg/m³, a CO emission concentration is 50-500 mg/m³, and a combustion efficiency of the low nitrogen fuel is beyond 95%.
